(19) United States
(12) Patent Application Publication
(10) Pub. No.: US 2005/0198152 A1
(43) Pub. Date: Sep. 8, 2005

(54) Computer with a personal digital assistant

(75) Inventor: Zachary Adam Garbow, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/777,260

(22) Filed: Feb. 12, 2004

(51) Int. Cl. G06F 15/16

(52) U.S. Cl. 709/206; 709/229

(57) ABSTRACT

A method, apparatus, system, and signal-bearing medium that in an embodiment determine whether a window meets a criteria. If the window meets the criteria, the window is sent to a personal digital assistant. If the window does meet the criteria, then the window is sent to a computer display. In an embodiment, the personal digital assistant is attached via a hinge to the computer and is capable of rotating via the hinge between a closed position atop a lid portion of the computer to an open position side-by-side with the lid portion. In this way, the display of the computer is viewable simultaneously with the personal digital assistant.

### FIELD

An embodiment of the invention generally relates to computers. In particular, an embodiment of the invention generally relates to a computer with a detachable, rotatable personal digital assistant.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. As advances in semiconductor processing and computer architecture push the performance of the computer hardware higher, more sophisticated and complex computer software has evolved to take advantage of the higher performance of the hardware, resulting in computer systems today that are much more powerful than just a few years ago. Thus, computer systems that once consumed a large room, now can fit on a desktop or even in a portable, notebook, or laptop computer.

Although laptop computers provide users with mobility, their physical size and their applications' processor requirements make them cumbersome for many simple tasks. Consequently, users have moved to personal digital assistants (PDAs) in order to manage simple and impulsive tasks, such as accessing a calendar or address book, jotting quick notes, using a calculator application, and playing music, just to name a few. Laptop computers are rarely considered practical for many of these lightweight tasks because powering the computer system on, loading an application, or waking the system from sleep mode in order to accomplish these simple or impulsive tasks takes too much time and is not worth the effort. While personal digital assistants are useful for small tasks, they unfortunately lack the memory, processing power, video screen size, and data input capabilities that are required in order to execute more sophisticated applications. Thus, neither personal digital assistants nor laptop computers provide the total solution that users need.

### SUMMARY

A method, apparatus, system, and signal-bearing medium are provided that in an embodiment determine whether a window meets a criteria. If the window meets the criteria, the window is sent to a personal digital assistant. If the window does meet the criteria, then the window is sent to a computer display. In an embodiment, the personal digital assistant is attached via a hinge to the computer and is capable of rotating via the hinge between a closed position atop a lid portion of the computer to an open position side-by-side with the lid portion. In this way, the display of the computer is viewable simultaneously with the personal digital assistant.

### BRIEF DESCRIPTION OF THE DRAWING

FIG. 1 depicts a perspective view of an example computer in a closed position with a rotatable, detachable personal digital assistant, according to an embodiment of the invention.

FIG. 2 depicts a perspective view of the example computer in an open position with a rotatable, detachable personal digital assistant, according to an embodiment of the invention.

FIG. 3 depicts a block diagram of the example computer and the personal digital assistant, according to an embodiment of the invention.

FIG. 4 depicts a flowchart of example processing for synchronizing data at the personal digital assistant, according to an embodiment of the invention.

FIG. 5 depicts a flowchart of example processing for receiving input from a keyboard, according to an embodiment of the invention.

FIG. 6 depicts a flowchart of example processing for handling windows, according to an embodiment of the invention.

### DETAILED DESCRIPTION

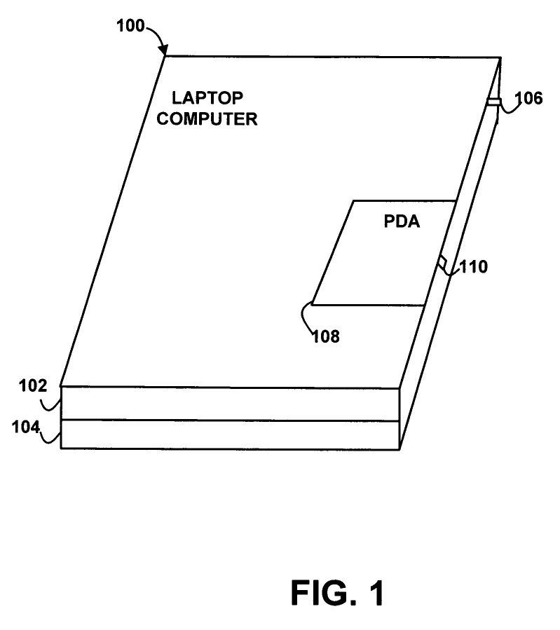

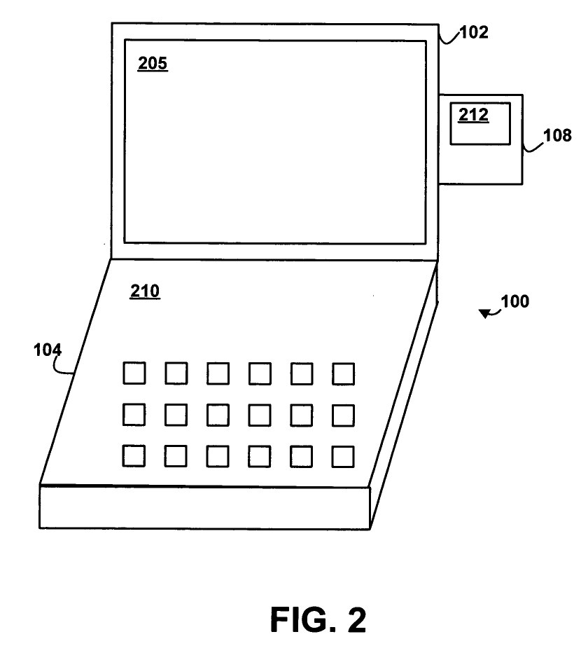

Referring to the Drawing, wherein like numbers denote like parts throughout the several views, FIG. 1 depicts a perspective view of an example computer 100 in a closed position with a rotatable, detachable personal digital assistant 108, according to an embodiment of the invention. The computer 100 includes a base portion 104 and a lid portion 102, which are connected via a hinge 106. The base portion 104 and the lid portion 102 rotate via the hinge 106 between a closed position, which is illustrated in FIG. 1 and an open position, which is illustrated in FIG. 2, as further described below.

The base portion 104 includes an unillustrated keyboard, and the lid portion 102 includes an unillustrated display screen. The personal digital assistant 108 attaches to the lid portion 102 and rotates via a hinge 110 between a closed position atop the lid portion 102, which is illustrated in FIG. 1, and an open position, which is illustrated in FIG. 2. The personal digital assistant 108 may be removed or detached from the lid portion 102 for operation independent of the computer 100. The personal digital assistant 108 may also operate independently of the computer 100 when attached to the computer 100. The personal digital assistant 108 may be connected electrically to the computer 100 via the hinge 110.

FIG. 2 depicts a perspective view of the example computer 100 in an open position with the rotatable, detachable personal digital assistant 108, according to an embodiment of the invention. The lid portion 102 includes a video or display screen 205. The base portion 104 includes a keyboard 210, but in other embodiments any appropriate type of input device may be used, and the input device may be a part of or separate from the base portion 104.

The personal digital assistant 108 is illustrated in the open position, where the personal digital assistant 108 is side-by-side with the lid portion 102 and the video screen 205. In this way, the user can view both the video screen 205 and the screen 212 of the personal digital assistant 108 simultaneously. In an embodiment, the screen 212 is a touchscreen and may be used with a stylus or finger to input data to the computer 100. In another embodiment, the personal digital assistant 108 may also include unillustrated keys or buttons for data input.

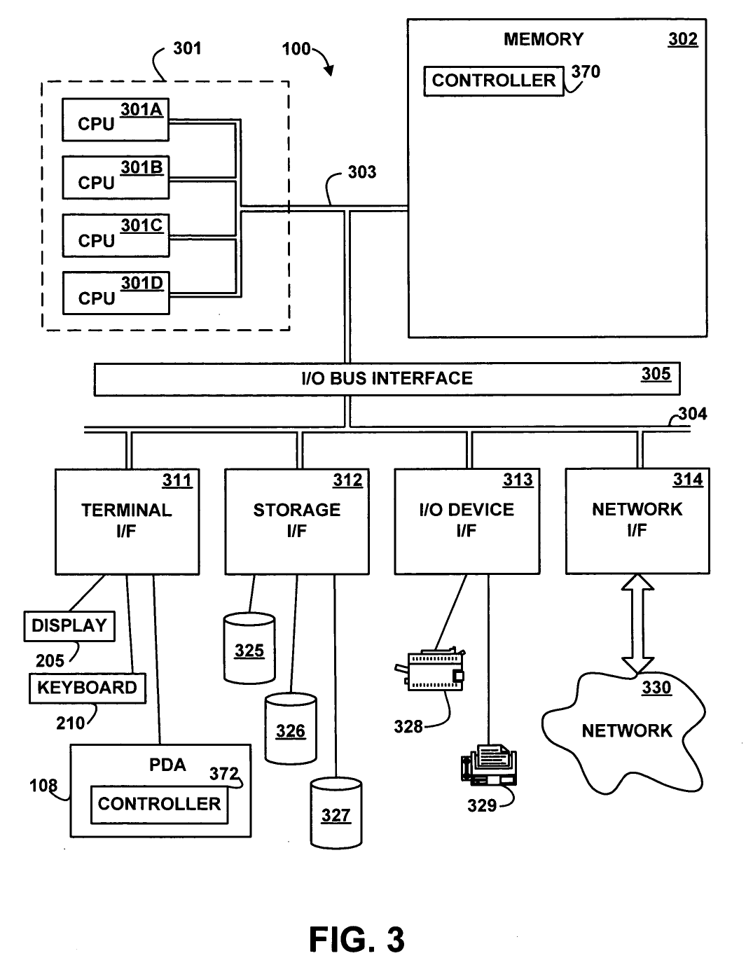

FIG. 3 depicts a high-level block diagram representation of the computer system 100 and the rotatable, detachable personal digital assistant 108, according to an embodiment of the present invention. The major components of the computer system 100 include one or more processors 301, a main memory 302, a terminal interface 311, a storage interface 312, an I/O (Input/Output) device interface 313, and communications/network interfaces 314, all of which are coupled for inter-component communication via a memory bus 303, an I/O bus 304, and an I/O bus interface unit 305.

The computer system 100 contains one or more general-purpose programmable central processing units (CPUs) 301A, 301B, 301C, and 301D, herein generically referred to as a processor 301. In an embodiment, the computer system 100 contains multiple processors typical of a relatively large system; however, in another embodiment the computer system 100 may alternatively be a single CPU system. Each processor 301 executes instructions stored in the main memory 302 and may include one or more levels of on-board cache.

The main memory 302 is a random-access semiconductor memory for storing data and programs. The main memory 302 is conceptually a single monolithic entity, but in other embodiments the main memory 302 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 302 includes a controller 370. Although the controller 370 is illustrated as being contained within the memory 302 in the computer system 100, in other embodiments, the controller 370 may be on different computer systems and may be accessed remotely, e.g., via the network 330. The computer system 100 may use virtual addressing mechanisms that allow the programs of the computer system 100 to behave as if they only have access to a large, single storage entity instead of access to multiple, smaller storage entities. Thus, while the controller 370 is illustrated as being contained within the main memory 302, various portions of the controller 370 are not necessarily all completely contained in the same storage device at the same time.

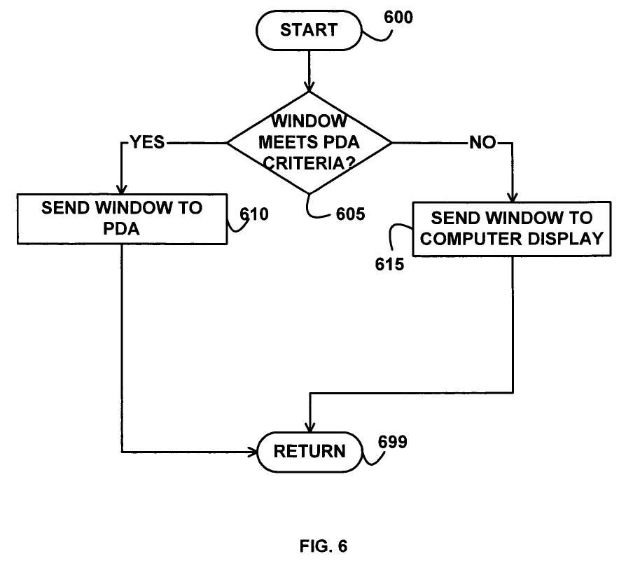

In an embodiment, the controller 370 includes instructions capable of executing on the processor 301 or statements capable of being interpreted by instructions executing on the processor 301 to perform the functions as further described below with reference to FIG. 6. In another embodiment, the controller 370 may be implemented in microcode. In another embodiment, the controller 370 may be implemented in hardware via logic gates and/or other appropriate hardware techniques.

The memory bus 303 provides a data communication path for transferring data among the processor 301, the main memory 302, and the I/O bus interface unit 305. The I/O bus interface unit 305 is further coupled to the system I/O bus 304 for transferring data to and from the various I/O units. The I/O bus interface unit 305 communicates with multiple I/O interface units 311, 312, 313, and 314, which are also known as I/O processors (IOPs) or I/O adapters (IOAs), through the system I/O bus 304. The system I/O bus 304 may be, e.g., an industry standard PCI bus, or any other appropriate bus technology.

The I/O interface units support communication with a variety of storage and I/O devices. For example, the terminal interface unit 311 supports the attachment of one or more video screens or displays 205, keyboards 210, and personal digital assistants 108. The storage interface unit 312 supports the attachment of one or more direct access storage devices (DASD) 325, 326, and 327 (which are typically rotating magnetic disk drive storage devices, although they could alternatively be other devices, including arrays of disk drives configured to appear as a single large storage device to a host). The contents of the main memory 302, or any portion thereof, may be stored to and retrieved from the direct access storage devices 325, 326, and 327.

The I/O and other device interface 313 provides an interface to any of various other input/output devices or devices of other types. Two such devices, the printer 328 and the fax machine 329, are shown in the exemplary embodiment of FIG. 3, but in other embodiment many other such devices may exist, which may be of differing types. The network interface 314 provides one or more communications paths from the computer system 100 to other digital devices and computer systems; such paths may include, e.g., one or more networks 330.

Although the memory bus 303 is shown in FIG. 3 as a relatively simple, single bus structure providing a direct communication path among the processors 301, the main memory 302, and the I/O bus interface 305, in fact the memory bus 303 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 305 and the I/O bus 304 are shown as single respective units, the computer system 100 may in fact contain multiple I/O bus interface units 305 and/or multiple I/O buses 304. While multiple I/O interface units are shown, which separate the system I/O bus 304 from various communications paths running to the various I/O devices, in other embodiments some or all of the I/O devices are connected directly to one or more system I/O buses.

The computer system 100 may be a multi-user “mainframe” computer system. Typically, in such a case the actual number of attached devices is greater than those shown in FIG. 3, although the present invention is not limited to systems of any particular size. The computer system 100 may alternatively be a single-user system, typically containing only a single user display and keyboard input. In other embodiments, the computer system 100 may be implemented as a personal computer, portable computer, laptop or notebook computer, tablet computer, pocket computer, telephone, pager, automobile, teleconferencing system, appliance, or any other appropriate type of electronic device.

The network 330 may be any suitable network or combination of networks and may support any appropriate protocol suitable for communication of data and/or code to/from the computer system 100. In various embodiments, the network 330 may represent a storage device or a combination of storage devices, either connected directly or indirectly to the computer system 100. In an embodiment, the network 330 may support Infiniband. In another embodiment, the network 330 may support wireless communications. In another embodiment, the network 330 may support hard-wired communications, such as a telephone line or cable. In another embodiment, the network 330 may support the Ethernet IEEE (Institute of Electrical and Electronics Engineers) 802.3x specification. In another embodiment, the network 330 may be the Internet and may support IP (Internet Protocol). In another embodiment, the network 330 may be a local area network (LAN) or a wide area network (WAN). In another embodiment, the network 330 may be a hotspot service provider network. In another embodiment, the network 330 may be an intranet. In another embodiment, the network 330 may be a GPRS (General Packet Radio Service) network. In another embodiment, the network 330 may be a FRS (Family Radio Service) network. In another embodiment, the network 330 may be any appropriate cellular data network or cell-based radio network technology. In another embodiment, the network 330 may be an IEEE 802.11B wireless network. In still another embodiment, the network 330 may be any suitable network or combination of networks. Although one network 330 is shown, in other embodiments any number of networks (of the same or different types) may be present.

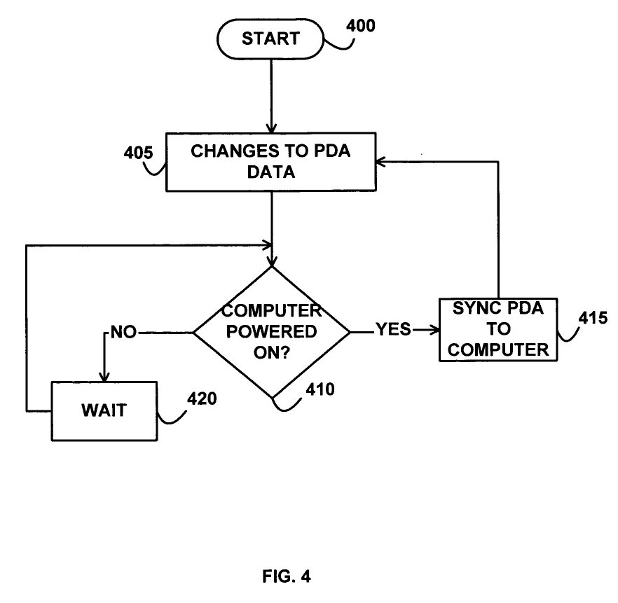

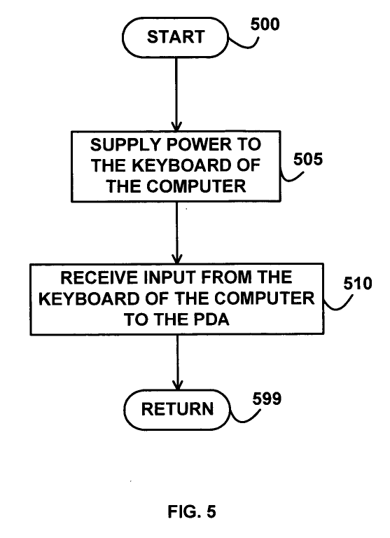

The personal digital assistant 108 includes a controller 372. In an embodiment, the controller 372 includes instructions capable of executing on an unillustrated processor in the personal digital assistant 108 or statements capable of being interpreted by instructions executing on the unillustrated processor to perform the functions as further described below with reference to FIGS. 4 and 5. In another embodiment, the controller 372 may be implemented in microcode. In another embodiment, the controller 372 may be implemented in hardware via logic gates and/or other appropriate hardware techniques. The personal digital assistant 108 may include other unillustrated elements such as memory and an operating system separate from the computer 100.

It should be understood that FIG. 3 is intended to depict the representative major components of the computer system 100 and the personal digital assistant 108 at a high level, that individual components may have greater complexity that represented in FIG. 3, that components other than or in addition to those shown in FIG. 3 may be present, and that the number, type, and configuration of such components may vary. Several particular examples of such additional complexity or additional variations are disclosed herein; it being understood that these are by way of example only and are not necessarily the only such variations.

The various software components illustrated in FIG. 3 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 301 in the computer system 100, cause the computer system 100 to perform the steps necessary to execute steps or elements embodying the various aspects of an embodiment of the invention. The computer programs may also typically comprise one or more instructions that are resident at various times in various memory and storage devices in the personal digital assistant 108, and that, when read and executed by one or more processors in the personal digital assistant 108, cause the personal digital assistant 108 to perform the steps necessary to execute steps or elements embodying the various aspects of an embodiment of the invention.

Moreover, while embodiments of the invention have and hereinafter will be described in the context of fully functioning computer systems and personal digital assistants, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 and the personal digital assistant 108 via a variety of signal-bearing media, which include, but are not limited to:
(1) information permanently stored on a non-rewriteable storage medium, e.g., a read-only memory device attached to or within a computer system, such as a CD-ROM readable by a CD-ROM drive;
(2) alterable information stored on a rewriteable storage medium, e.g., a hard disk drive (e.g., DASD 125, 126, or 127) or diskette; or
(3) information conveyed to the computer system 100 or the personal digital assistant 108 by a communications medium, such as through a computer or a telephone network, e.g., the network 330, including wireless communications.

Such signal-bearing media, when carrying machine-readable instructions that direct the functions of the present invention, represent embodiments of the present invention.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 3 are not intended to limit the present invention. Indeed, other alternative hardware and/or software environments may be used without departing from the scope of the invention.

FIG. 4 depicts a flowchart of example processing for synchronizing data at the personal digital assistant 108, according to an embodiment of the invention. Control begins at block 400. Control then continues to block 405 where the controller 372 detects that changes have been made to the data at the personal digital assistant 108. Control then continues to block 410 where the controller 372 determines whether the computer 100 is powered on. If the determination at block 410 is true, then control continues to block 415 where the controller 372 and the controller 370 synchronize the data at the personal digital assistant 108 with the data at the computer 100. The synchronization may involve copying data from the personal digital assistant 108 to the computer 100 and/or copying data from the computer 100 to the personal digital assistant 108. Control then returns to block 405, as previously described above.

If the determination at block 410 is false, then the computer 100 is not powered on, so control continues to block 420 where the controller 372 waits for a period of time. Control then returns to block 410, as previously described above.

In this way, data is synchronized between the personal digital assistant 108 and the computer 100 whenever the computer is powered on.

FIG. 5 depicts a flowchart of example processing, according to an embodiment of the invention. Control begins at block 500. Control then continues to block 505 where the controller 372 in the personal digital assistant 108 instructs the power supply of the computer 100 to supply power to the input device of the computer 100, such as the keyboard 210, but in other embodiments any appropriate input device may be used, such as a mouse, touchpad, trackball, pointing stick, microphone, or speech recognition device. Although the keyboard 210 is illustrated (in FIG. 2) as being part of the base portion 104 of the computer 100, in other embodiments the input device may be separate from the computer 100 and attached to, connected to, or in communication with the computer 100.

Control then continues to block 510 where the controller 372 receives input from the input device of the computer 100. Control then continues to block 599 where the logic of FIG. 5 returns. In this way, even if the computer system 100 is turned off, the computer keyboard or other input device can be used to enter data into the personal digital assistant 108, which is beneficial since data entry to personal digital assistants is often cumbersome.

FIG. 6 depicts a flowchart of example processing for handling windows, according to an embodiment of the invention. Control begins at block 600. Control then continues to block 605 where the controller 370 determines whether a window meets a PDA criteria. In various embodiments a window may be any data capable of being displayed on display screen, a portion of a display screen, or any other appropriate data. The criteria reflects whether the window is suitable for display at the personal digital assistant 108, which typically has a smaller screen than the display 205 of the computer 100, such as the video display screen 212. Examples of windows that meet the PDA criteria are small distracting windows, such as an instant messaging window, a media player window, a calendar window, a calculator application window, or an e-mail window.

If the determination at block 605 is true, then the window does meet the PDA criteria, so control continues to block 610 where the controller 370 sends the window to the personal digital assistant 108 and the controller 372 displays the window on the display 212 of the personal digital assistant 108. Control then continues to block 699 where the logic of FIG. 6 returns.

If the determination at block 605 is false, then the window does not meet the PDA criteria, so control continues to block 615 where the controller 170 sends the window to the computer display 205. Control then continues to block 699 where the logic of FIG. 6 returns. In this way, the personal digital assistant 108 provides an outlet for small windows that can be a distraction to normal processing of applications of the computer system 100.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

1. A method comprising:
determining whether data meets a criteria;
if the determining is true, sending the data to a personal digital assistant; and
if the determining is false, sending the data to a computer display.

2. The method of claim 1, wherein the determining further comprises:
determining whether the data comprises an instant messaging application window.

3. The method of claim 1, wherein the determining further comprises:
determining whether the data comprises a calculator application window.

4. The method of claim 1, wherein the determining further comprises:
determining whether the data comprises a calendar application window.

5. The method of claim 1, wherein the determining further comprises:
determining whether the data comprises a media player application window.

6. The method of claim 1, wherein the determining further comprises:
determining whether the data comprises an e-mail application window.

7. An apparatus comprising:
means for determining whether a window meets a criteria;
means for sending the window to a personal digital assistant if the determining is true, wherein the personal digital assistant is detachably connected via a hinge to a computer; and
means for sending the window to a computer display if the determining is false, wherein the computer comprises the computer display.

8. The apparatus of claim 7, wherein the means for determining further comprises:
means for determining whether the window comprises an instant messaging application window.

9. The apparatus of claim 7, wherein the means for determining further comprises:
means for determining whether the window comprises a calculator application window.

10. The apparatus of claim 7, wherein the means for determining further comprises:
means for determining whether the window comprises a calendar application window.

11. The apparatus of claim 7, wherein the means for determining further comprises:
means for determining whether the window comprises a media player application window.

12. The apparatus of claim 7, wherein the means for determining further comprises:
means for determining whether the window comprises an e-mail application window.

13. A signal-bearing medium encoded with instructions, wherein the instructions when executed comprise:
instructing a power supply of a computer to supply power to an input device of the computer; and
receiving input at a personal digital assistant from the input device of the computer.

14. The signal-bearing medium of claim 13, further comprising:
determining that data has been changed at the personal digital assistant;
determining whether the computer is powered on; and
if the data has been changed at the personal digital assistant and the computer is powered on, synchronizing the data with the computer.

15. The signal-bearing medium of claim 13, wherein the personal digital assistant is rotatably and detachably connected to the computer.

16. A system comprising:
a computer comprising a base portion and a lid portion; and
a personal digital assistant detachably connected to the lid portion via a hinge, wherein the personal digital assistant is capable of rotating via the hinge.

17. The system of claim 16, wherein the personal digital assistant is capable of rotating via the hinge between a closed position atop the lid portion and an open position side-by-side with the lid portion.

18. The system of claim 17, wherein the lid portion comprises a display, and wherein in the open position the personal digital assistant is viewable simultaneously with the display.

19. The system of claim 18, wherein the computer further comprises:
a processor; and
a main memory encoded with instructions, wherein the instructions when executed on the processor comprise:
determining whether a window meets a criteria,
if the determining is true, sending the window to the personal digital assistant, and
if the determining is false, sending the window to the display.

20. The system of claim 19, wherein the instructions further comprise:
sending input from an input device in the base portion to the personal digital assistant.
